(19) United States
(12) Patent Application Publication
(10) Pub. No.: US 2016/0162835 A1
(43) Pub. Date: Jun. 9, 2016

(54) DEVICE FOR ALLOCATING SHIPS, METHOD FOR ALLOCATING SHIPS, PROGRAM AND RECORDING MEDIA THEREOF

(71) Applicant: NIPPON YUSEN KABUSHIKI KAISHA, Tokyo (JP)

(72) Inventors: Yuji OTSUKA, Tokyo (JP); Atsushi YAMAGUCHI, Tokyo (JP); Masaharu URABE, Tokyo (JP); Ryo KAKUTA, Tokyo (JP)

(73) Assignee: NIPPON YUSEN KABUSHIKI KAISHA, Tokyo (JP)

(21) Appl. No.: 14/906,042

(22) PCT Filed: Jul. 19, 2013
(86) PCT No.: PCT/JP2013/069640

§ 371 Date: Jan. 19, 2016

(51) Int. Cl. G06Q 10/08

(52) U.S. Cl. CPC G06Q 10/0834

(57) ABSTRACT

Ship allocating device obtaining a shipping route data set indicating a shipping route of a routine transportation service, a ship number data set that indicates a number of ships used for the routine transportation service, and a schedule data set that indicates a schedule of assignments of ships for the routine transportation service. The ship allocating device obtains data sets indicating fluctuations in fuel consumption of ships. The ship allocating device calculates, for each of the candidate ships, fuel consumption required for the ship to traverse the shipping route indicated by the shipping route data set in accordance with a schedule indicated by the schedule data set based on the data set. The ship allocating device selects a number of ships equal to or greater than the number indicated by the ship number data set based on calculated fuel consumptions, and outputs data sets identifying selected ships.

### TECHNICAL FIELD

This invention relates to a technique for selecting ships that are most suitable for performing predetermined shipping assignments.

### BACKGROUND ART

There is known in the art a method for selecting a ship that is most suitable for performing a predetermined shipping assignment from among plural candidate ships, based on costs incurred for performing predetermined the assignment. For example, JP Hei-8-272402A discloses in paragraph 0027 a method for selecting a ship that is suitable for transporting a cargo based on costs incurred for the transportation including a fee for chartering the ship. According to the method disclosed in JP Hei-8-272402A, a ship that is chartered at a low cost is selected for transportation, and a total cost for the transportation is reduced.

Other than a fee for chartering a ship, a charge for fuel consumed by a ship is also a non-negligible parameter influencing a total cost required for the transportation. For example, it is assumed that plural candidate ships are available for a certain shipping assignment and the ships have different fuel efficiencies. If a ship with a low charter fee but with low fuel efficiency is selected for the assignment, a total cost for the assignment may become comparatively expensive because of high fuel costs. In a situation where plural ships are used for routine transportation service such as a weekly transportation service where plural ships call at a certain port weekly, on a specified weekday, by rotation for transporting a cargo, if inefficient ships are selected for the service, a total cost of the service may become unnecessarily large because of high fuel costs for operating the ships. Since the price of crude oil has been increasing recently, the marine cargo transportation business may encounter serious difficulties if fuel consumption for the service cannot be kept low, and fuel charges becomes high.

### SUMMARY

In view of the foregoing, it is an object of the present invention to provide a technique for selecting ships that are most suitable for performing predetermined shipping assignments when plural ships are used for a marine transportation service.

To solve the above explained problem, this invention provides a device for allocating ships comprising: a first data obtaining unit that obtains a shipping route data set indicating a shipping route of a routine transportation service, ship identification data sets that indicate candidate ships available for the routine transportation service, a ship number data set that indicates a number of ships used for the routine transportation service, and a schedule data set that indicates a schedule of assignments of ships for the routine transportation service, a second data obtaining unit that obtains, from a first database that stores fuel consumption fluctuation data sets each of which indicates a fluctuation of fuel consumption of a ship in association with ship identification, data sets each of which in turn indicates a corresponding ship, fuel consumption fluctuation data sets stored in association with the ship identification data sets obtained by the first data obtaining unit, a calculating unit that calculates, in connection with each of the candidate ships, fuel consumption required for the ship to traverse the shipping route indicated by the shipping route data set in accordance with a schedule indicated by the schedule data set based on the fuel consumption fluctuation data set of the ship, a selecting unit that selects, from among the candidate ships, a number of ships equal to or greater than the number indicated by the ship number data set based on the fuel consumptions calculated by the calculating unit, and an outputting unit that outputs the ship identification data sets of the ships selected by the selecting unit.

This invention also provides, as a preferred embodiment, the above mentioned device further comprising: a third data obtaining unit that obtains, from a second database, a meteorological and hydrographic phenomenon data set indicating meteorological and hydrographic phenomena in relation to the schedule indicated by the schedule data set and in relation to the shipping route indicated by the shipping route data set, wherein the first database stores meteorological and hydrographic phenomenon data sets in association with the fuel consumption fluctuation data sets, and the calculating unit calculates the fuel consumption based on the meteorological and hydrographic phenomenon data sets.

This invention also provides, as another preferred embodiment, the above-mentioned device wherein the first data obtaining unit obtains a plurality of the schedule data sets, the calculating unit calculates a fuel consumption of each of the candidate ships in connection with each of plural schedules indicated by the plurality of schedule data sets, the selecting unit selects, in connection with each of the plural schedules, a number of ships equal to or greater than the number indicated by the ship number data set based on the fuel consumptions calculated by the calculating unit, and the outputting unit outputs, in connection with each of the plural schedules, the ship identification data sets of the ships selected by the selecting unit, and further comprising: a display unit that displays, in connection with each of the plural schedules, the ship identification data sets output by the outputting unit.

This invention also provides a method for allocating ships comprising:

obtaining a shipping route data set indicating a shipping route of a routine transportation service, ship identification data sets that indicate candidate ships available for the routine transportation service, a ship number data set that indicates a number of ships used for the routine transportation service, and a schedule data set that indicates a schedule of assignments of ships for the routine transportation service, obtaining, from a first database that stores fuel consumption fluctuation data sets each of which indicates a fluctuation of fuel consumption of a ship in association with ship identification data sets, each of which in turn indicates a corresponding ship, fuel consumption fluctuation data sets stored in association with the obtained ship identification data sets, calculating, in connection with each of the candidate ships, fuel consumption required for the ship to traverse the shipping route indicated by the shipping route data set in accordance with a schedule indicated by the schedule data set based on the fuel consumption fluctuation data set of the ship, selecting, from among the candidate ships, a number of ships equal to or greater than the number indicated by the ship number data set based on the calculated fuel consumptions, and outputting the ship identification data sets of the selected ships.

This invention also provides a program that causes a computer to execute: obtaining a shipping route data set indicating a shipping route of a routine transportation service, ship identification data sets that indicate candidate ships available for the routine transportation service, a ship number data set that indicates a number of ships used for the routine transportation service, and a schedule data set that indicates a schedule of assignments of ships for the routine transportation service, obtaining, from a first database that stores fuel consumption fluctuation data sets each of which indicates a fluctuation of fuel consumption of a ship in association with ship identification data sets, each of which in turn indicates a corresponding ship, fuel consumption fluctuation data sets stored in association with the obtained ship identification data sets, calculating, in connection with each of the candidate ships, fuel consumption required for the ship to traverse the shipping route indicated by the shipping route data set in accordance with a schedule indicated by the schedule data set based on the fuel consumption fluctuation data set of the ship, selecting, from among the candidate ships, a number of ships equal to or greater than the number indicated by the ship number data set based on the calculated fuel consumptions, and outputting the ship identification data sets of the selected ships.

This invention also provides a computer readable recording medium storing the above-mentioned program.

According to the present invention, when plural ships are used for a shipping assignment, ships suitable for the assignment are determined.

### BRIEF DESCRIPTION OF THE DRAWINGS

FIG. 1 A drawing illustrating an entire configuration of ship allocating system 1.

FIG. 2 A drawing illustrating data sets stored in ship database 300.

FIG. 3 A drawing illustrating a sample of a fuel consumption table.

FIG. 4 A drawing illustrating a relation between vessel speed and fuel consumption.

FIG. 5 A drawing illustrating data sets stored in meteorological and hydrographic phenomenon database 400.

FIG. 6 A drawing illustrating a hardware configuration of ship allocating device 100.

FIG. 7 A drawing illustrating a functional configuration of ship allocating device 100.

FIG. 8 A drawing illustrating a flow of processes executed by control unit 110.

FIG. 9 A drawing illustrating a sample of shipping route of routine transportation service.

FIG. 10 A drawing illustrating a chart for explaining processing performed in the exemplary embodiment.

FIG. 11 A drawing illustrating a sample of screen displayed by display unit 150.

### DETAILED DESCRIPTION

### Exemplary Embodiment

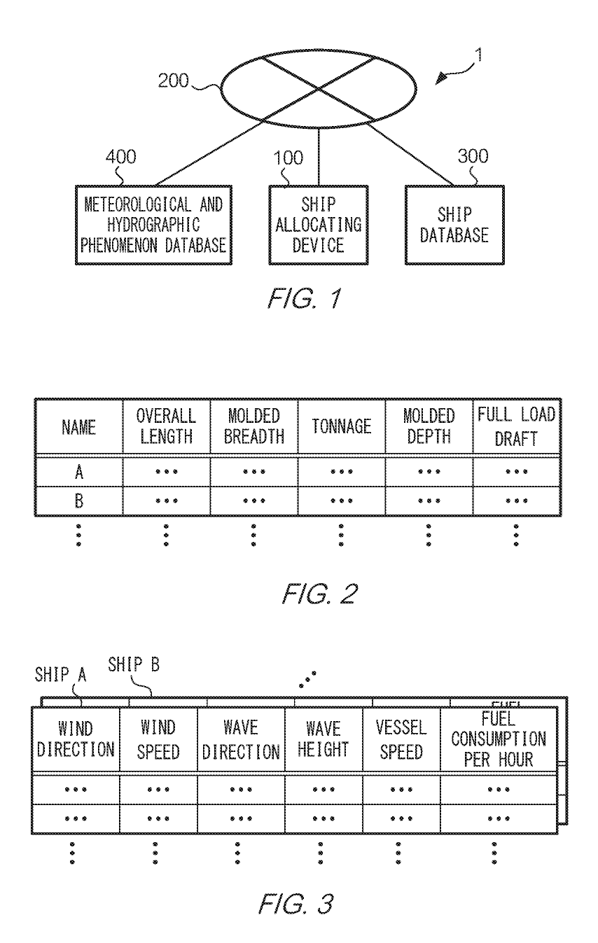

FIG. 1 shows an entire configuration of ship allocating system 1 according to an exemplary embodiment of the present invention. Ship allocating system 1 is a system for indicating to a user ships that are most suitable for performing predetermined shipping assignments. A user determines ships to be used for the marine transportation in accordance with a certain schedule by referring to the information indicated by ship allocating system 1.

Network 200 is a network for data communications among data communication devices. Network 200 may be configured as a wired network, a wireless network, or a combination of wired and wireless networks.

Ship database 300 (first database) is a database that stores data sets indicating information on ships. As shown in FIG. 2, ship database 300 stores, in connection with each of the ships, a name, an overall length, a molded breadth, a tonnage, a molded depth, a full load draft, etc. as information on the ship. Ship database 300 also stores, in connection with each of the ships, a fuel consumption table indicating fluctuations of fuel consumption of the ship as shown in FIG. 3 in association with a ship identification data set identifying the ship. The fuel consumption table stores plural records, each of which stores a wind direction, a wind speed, a wave direction, a wave height, a vessel speed, fuel consumption per hour, etc.

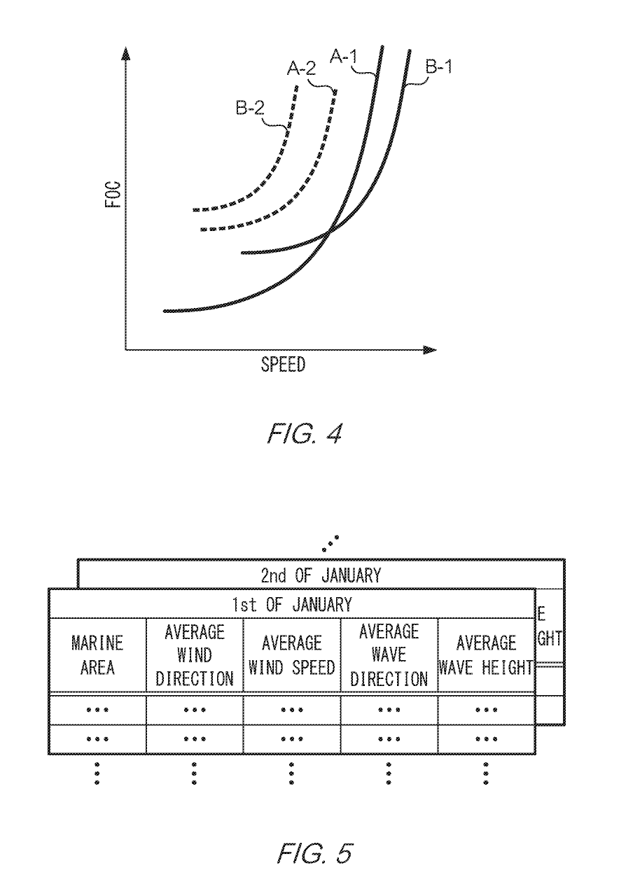

FIG. 4 shows graphs indicating relations between vessel speeds (Speed) and fuel consumptions per hour (FOC) stored in the fuel consumption tables. Graph A-1 shown in FIG. 4 is a graph indicating a relation between vessel speeds and fuel consumptions per hour in connection with a ship identified as Ship A under certain meteorological and hydrographic phenomena. Graph B-1 shown in FIG. 4 is a graph indicating a relation between vessel speeds and fuel consumptions per hour in connection with a ship identified as Ship B under the certain meteorological and hydrographic phenomena. According to graphs A-1 and B-1 shown in FIG. 4, under the certain meteorological and hydrographic phenomena, the lowest vessel speed of Ship A is lower than the lowest vessel speed of Ship B, and fuel consumption per hour of Ship A is smaller than that of Ship B when vessel speeds of the ships exceed a certain value. Moreover, according to graphs A-1 and B-1, a range of vessel speed for marine navigation of Ship A is wider than that of Ship B under the certain meteorological and hydrographic phenomena.

Graph A-2 shown in FIG. 4 is a graph indicating a relation between vessel speeds and fuel consumptions per hour in connection with Ship A under a phenomenon with a wave height higher than that indicated in graph A-1. Similarly, graph B-2 shown in FIG. 4 is a graph indicating a relation between vessel speeds and fuel consumptions per hour in connection with Ship B under the same phenomenon as that indicated in graph A-2. According to graphs A-2 and B-2 shown in FIG. 4, the higher a wave height becomes, the lower the lowest vessel speeds and the highest vessel speeds become in connection with each of Ship A and Ship B. Moreover, according to graphs A-2 and B-2, under the phenomenon with the higher wave height, fuel consumption per hour of Ship B is higher than that of Ship A at any vessel speed.

Types of data sets stored in ship database 300 are not limited to the above-mentioned types of data sets, and any other type of data set indicating information relating to fuel consumption of ships such as accumulated grime on a ship's hull, accumulated grime on a ship's screw propeller, etc. may be stored in ship database 300.

Meteorological and hydrographic phenomenon database 400 (second database) is a database that stores data sets indicating information on meteorological and hydrographic phenomena in connection with each marine area. FIG. 5 shows samples of types of data sets stored in meteorological and hydrographic phenomenon database 400. Namely, meteorological and hydrographic phenomenon database 400 stores, in connection with individual dates, data sets indicating statistical information on meteorological and hydrographic phenomena such as an average wind direction, an average wind speed, an average wave direction, an average wave height, etc. in each of predetermined marine areas. Types of data sets stored in meteorological and hydrographic phenomenon database 400 are not limited to the above-mentioned types of data sets, and data sets indicating any other types of meteorological and hydrographic phenomena such as ocean drift, tidal current, etc. may be stored.

Ship allocating device 100 is a device that indicates to a user ships that are most suitable for performing predetermined shipping assignments such as an assignment for transporting containers designated by the user. Ship allocating device 100 obtains data sets from ship database 300 and meteorological and hydrographic phenomenon database 400, and displays information on ships suitable for performing shipping assignments designated by the user based on the obtained data sets. The information on the ships displayed by ship allocating device 100 includes, for example, names of the ships for identification. The information displayed by ship allocating device 100 may include information other than names of the ships, such as ranges of vessel speed of the ships, tonnage of the ships, etc.

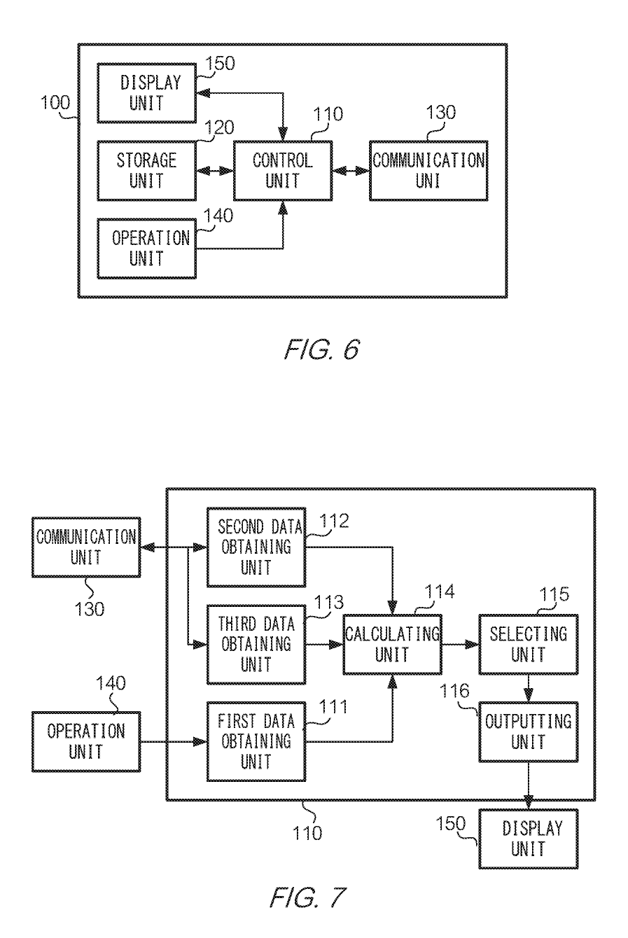

FIG. 6 shows a block diagram of a hardware configuration of ship allocating device 100. Ship allocating device 100 is a computer that executes programs, and comprises control unit 110, storage unit 120, communication unit 130, operation unit 140 and display unit 150. Ship allocating unit 100 may be any type of computer that executes computer programs, such as a personal computer.

Storage unit 120 is a unit that stores programs and data sets. Storage unit 120 comprises, for example, a hard disk drive, and stores programs that are executed by control unit 110, data sets used by control unit 110, etc. Storage unit 120 stores a program for realizing a function for indicating to a user ships suitable for performing shipping assignments designated by the user.

Communication unit 130 is connected to network 200, and controlled by control unit 110. Under the control of control unit 110, communication unit 130 communicates with other communication devices connected to network 200. Communication unit 130 receives data sets indicating information on ships transmitted from ship database 300. Communication unit 130 also receives data sets indicating information on meteorological and hydrographic phenomena transmitted from meteorological and hydrographic phenomenon database 400.

Operation unit 140 may include a mouse pointer and a keyboard that are operated by a user. The user may operate the mouse pointer and the keyboard to input various types of data sets such as data sets indicating information on the water route for the routine transportation service. Operation unit 140 may include a touch screen instead of a mouse pointer and a keyboard.

Display unit 150 is a unit that displays information. Display unit 150 may comprise a display device such as a liquid crystal display, and displays information provided by control unit 110. Display unit 150 may output information to be displayed to a display device such as a liquid crystal display device and a projector connected to ship allocating device 100 instead of displaying the information by itself.

Control unit 110 comprises CPU (Central Processing Unit) and RAM (Random Access Memory), and executes programs stored by storage unit 120 to control each of the other units of ship allocating device 100. When control unit 100 executes the programs stored by storage unit 120, the function for indicating ships suitable for performing shipping assignments designated by a user is realized.

FIG. 7 shows a block diagram of a functional configuration realized when control unit 110 executes the programs. When control unit 110 executes the programs stored by storage unit 120, first data obtaining unit 111, second data obtaining unit 112, third data obtaining unit 113, calculating unit 114, selecting unit 115 and outputting unit 116 are realized.

First data obtaining unit 111 is a unit that obtains data sets input by a user by use of operation unit 140. The user inputs data sets indicating information on a shipping route for the routine transportation service by use of operation unit 140. First data obtaining unit 111 outputs the obtained data sets to calculating unit 114. In this exemplary embodiment, a name of port of origin, a name of destination port, marine areas on a shipping route, names of ports of call, numbers of days spent moving between ports, distances between ports, sailing date, a number of ships used for the routine transportation service, etc. are input by the user as data sets indicating information on the shipping route for the routine transportation service. Types of data sets input to ship allocating device 100 by the user are not limited to the above-mentioned types of data sets, and any types of data sets relating to the shipping route for the routine transportation service may be input to ship allocating device 100.

Third data obtaining unit 113 is a unit that obtains data sets from meteorological and hydrographic phenomenon database 400. Third data obtaining unit 113 obtains from meteorological and hydrographic phenomenon database 400 data sets indicating information on meteorological and hydrographic phenomena in marine areas on the shipping route for the routine transportation service at timings when ships pass through the marine areas. Third data obtaining unit 113 outputs the obtained data sets to calculating unit 114.

Second data obtaining unit 112 is a unit that obtains data sets stored in ship database 300. Second data obtaining unit 112 obtains from ship database 300 various types of data sets shown in FIG. 2 and FIG. 3.

Calculating unit 114 is a unit that calculates, in connection with each of the ships whose names are stored in ship database 300, a fuel consumption required for the ship to traverse the shipping route of the routine transportation service based on the data sets obtained by first data obtaining unit 111, second data obtaining unit 112 and third data obtaining unit 113. Calculating unit 114 calculates, in connection with each of the ships whose names are stored in ship database 300, a fuel consumption required for the ship to traverse the shipping route indicated by the data sets obtained by first data obtaining unit 111 by use of the data sets obtained by second data obtaining unit and the meteorological and hydrographic phenomenon data sets obtained by third data obtaining unit 113.

Selecting unit 115 is a unit that selects a certain number of ships for the shipping route for the routine transportation service indicated by the data sets obtained by the first data obtaining unit 111 from among the ships whose names are stored in ship database 300 based on the fuel consumptions calculated by calculating unit 114.

Outputting unit 116 is a unit that outputs results of the selection executed by selecting unit 115. Outputting unit 116 outputs to display unit 150 data sets indicating the ships selected by selecting unit 115. In this exemplary embodiment, outputting unit 116 outputs to display 150 data sets indicating a screen image that displays names of the selected ships indicated by the data sets obtained from ship database 300.

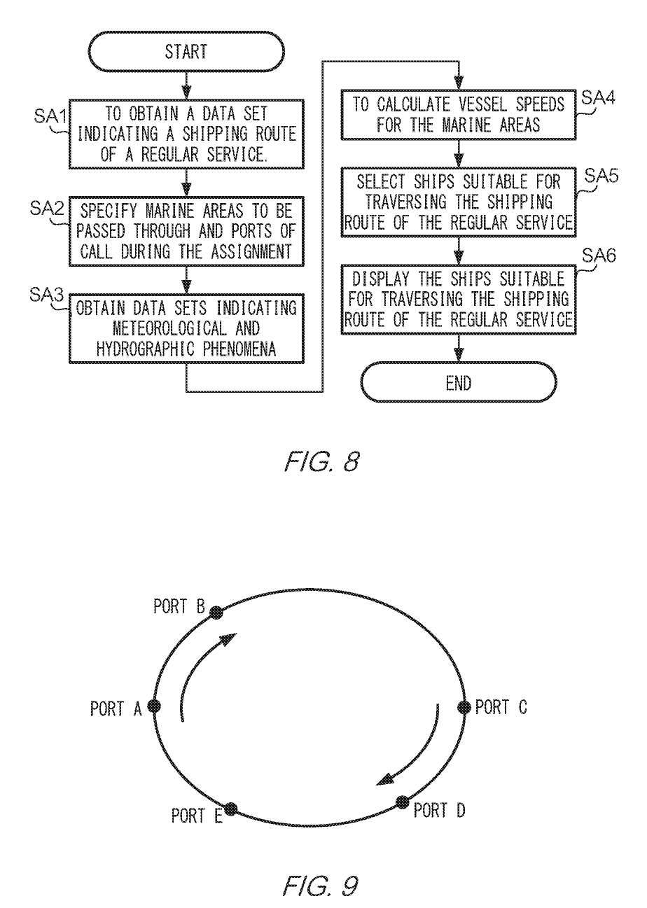

An example of flow of processes executed by ship allocating system 1 is explained below. FIG. 8 is a flowchart indicating a flow of processes executed by control unit 110 when ship allocating device 100 indicates to a user ships suitable for performing shipping assignments designated by the user.

When a user of ship allocating system 1 wishes to know which ships are suitable for performing shipping assignments according to a routine transportation service following a certain schedule, the user inputs to ship allocating device 100 data sets indicating information on the routine transportation service by use of a keyboard and a mouse pointer of operation unit 140. The data sets input by the user may include, for example, a name of a port of origin, a name of destination port, marine areas on a shipping route, names of ports of call, numbers of days spent moving between ports, distances between ports, sailing date, and a number of ships used for the routine transportation service. Control unit 110 obtains the data sets that the user inputs by use of operation unit 140 (step SA1).

Next, control unit 110 calculates, in connection with each of ships whose information is stored in ship database 300, fuel consumption of the ship from the port of origin to the destination port in accordance with the schedule (for example, the number of days spent moving between the ports and the sailing date) by use of the data sets obtained in step SA1.

More concretely, control unit 110 specifies marine areas and ports of call between the port of origin and the destination port based on the data sets obtained in step SA1 (step SA2). Then, control unit 110 obtains from meteorological and hydrographic phenomenon database 400 data sets indicating meteorological and hydrographic phenomena in the marine areas at the timings when the ship is to pass through the marine areas specified in step SA2 (step SA3).

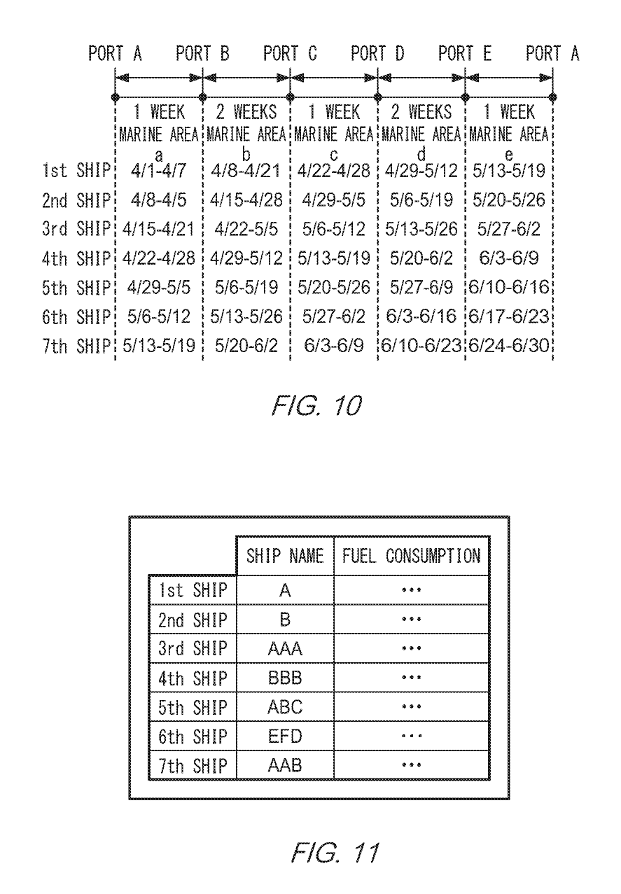

In the following, for ease of explanation, it is assumed that 7 ships are used for the routine transportation service where the ships traverse the shipping route shown in FIG. 9, namely the ships depart from port A, call at ports B, C, D, and E in this order, and return to port A, in accordance with the schedule shown in FIG. 10; namely, the ships move from port A to port B in one week, from port B to port C in two weeks, from port C to port D in one week, from port D to port E in two weeks, and from port E to port A in one week.

In this case, control unit 110 obtains data sets indicating the port of origin, the destination port, the ports of call, and the order of visiting the ports of call, that specify the shipping route, and obtains data sets indicating the sailing date and the number of days spent moving between the ports in connection with each of the ships that specifies the schedule. The data sets for specifying the shipping route may include data sets indicating information on marine areas on the shipping route and data sets indicating distances between the ports. Control unit 110 specifies marine areas a, b, c, d, and e on the shipping route from the port of origin to the destination port as shown in FIG. 10. Control unit 110 also specifies dates when each of the ships used for the routine transportation service passes each of the marine areas as shown in FIG. 10 based on the sailing date for the routine transportation service, and obtains data sets indicating meteorological and hydrographic phenomena in the marine areas on the specified dates. For example, when the 1st ship passes through marine area a between April 1 and April 7 as shown in FIG. 10, control unit 110 obtains data sets indicating meteorological and hydrographic phenomena in marine area a between April 1 and April 7. Similarly, for example, when the 2nd ship passes through marine area a between April 8 and April 14, control unit 110 obtains data sets indicating meteorological and hydrographic phenomenon in marine area a between April 8 and April 14.

Moreover, control unit 110 specifies distances between the ports on the shipping route for the routine transportation service based on the data sets obtained in step SA1, and calculates vessel speeds of the ships in each of the marine areas based on the data sets obtained in step SA1 (step SA4). Next, control unit 110 selects ships that are suitable for the routine transportation service (step SA5).

More concretely, control unit 110 first selects the 1st ship used for the shipping route. For example, when data sets indicating meteorological and hydrographic phenomena in marine area a and data sets indicating calculated vessel speeds are stored in the 1st record of fuel consumption table of ship A as shown in FIG. 3, control unit 110 obtains the data set indicating fuel consumption per hour stored in the 1st record of the fuel consumption table. Similarly, for example, when data sets indicating meteorological and hydrographic phenomena in marine area a and data sets indicating calculated vessel speeds are stored in the 3rd record of fuel consumption table of ship B, control unit 110 obtains the data set indicating fuel consumption per hour stored in the 3rd record of the fuel consumption table. For example, if no data set indicating meteorological and hydrographic phenomena in marine area a is stored in the fuel consumption table when information on the meteorological and hydrographic phenomena in marine area a is required, control unit 110 may use a data set indicating a fuel consumption per hour of a record of the fuel consumption table that stores a data set indicating meteorological and hydrographic phenomena close to meteorological and hydrographic phenomena in marine area a. Control unit 110 calculates fuel consumption per day for each of the ships based on the fuel consumptions per hour. Control unit 110 performs the above-explained calculations in connection with each of the ships in connection with each of the marine areas to determine, for example, fuel consumption required for each of marine areas a to e in connection with each of the ships.

Next, control unit 110 calculates, in connection with each of the ships whose information is stored in ship database 300, the fuel consumptions in the marine areas to determine total fuel consumption required from the port of origin to the destination port. After control unit 110 calculates the total fuel consumption in connection with each of the ships, control unit 110 selects a ship whose total fuel consumption is the lowest as the 1st ship for the routine transportation service.

When control unit 110 has selected the 1st ship for the routine transportation service, control unit 110 selects the 2nd ship for the routine transportation service in the same way as for the 1st ship. Since the dates when the 2nd ship passes the marine areas on the water route for the routine transportation service are different from those of the 1st ship, meteorological and hydrographic phenomena encountered by the 2nd ship in the marine areas may be different from meteorological and hydrographic phenomena encountered by the 1st ship in the same marine areas. Control unit 110 calculates total fuel consumption in connection with each of the ships, and selects a ship whose total fuel consumption is the lowest as the 2nd ship for the routine transportation service, under the condition that the ship that is already selected as the 1st ship for the routine transportation service is eliminated as a candidate for selection as the 2nd ship.

Control unit 110 selects the 3rd ship and the subsequent ships for the routine transportation service in a manner similar to that used for selecting the 2nd ship for the routine transportation service. After control unit 110 has selected all of the ships for the routine transportation service, control unit 110 generates a screen showing names of the selected ships (information to identify the ships) in the order of selection, and outputs a data set indicating the screen to display unit 150 (step SA6).

FIG. 11 is a sample of a screen displayed by display unit 150. As shown in FIG. 11, display unit 150 displays a list of names of ships that are suitable to be used for the routine transportation service. Accordingly, a user of ship allocating device 100 can tell which ships should be used for the routine transportation service to minimize cost from the viewpoint of fuel consumption.

In this exemplary embodiment, when a data set indicating a schedule of assignments, a data set indicating a minimum tonnage or a minimum number of containers that a ship is capable of carrying may be input as a condition required for the ship to be used for the routine transportation service, and ship allocating device 100 may select ships according to the input condition and display the selected ships. In the case, for example, when “a” ton is input as a minimum tonnage of a ship, display unit 150 does not display the name of any ship whose maximum load is less than “a” ton on the screen. Similarly, for example, when “b” is input as a minimum number of containers to be loaded onto a ship, display unit 150 does not display the name of any ship that is only capable of carrying a number of containers smaller than “b” on the screen.

### [Modifications]

The present invention should not be limited to the above-explained exemplary embodiment, and this invention may be implemented in various embodiments. For example, the present invention may be implemented in the modified embodiments explained in the following sections or combinations of the embodiments.

In the present invention, a flow of processes to calculate fuel consumption of each of the ships is not limited to the above-explained flow. For example, when excrescence such as shells or seaweed has accumulated on a ship's hull or a screw propeller, the excrescence increase water resistance in driving of the ship and increase fuel consumption. Accordingly, ship database 300 may store data sets indicating information on quantities of excrescence stuck to ships, and control unit 110 may correct calculations of fuel consumptions per hour of the ships based on the quantities of excrescence indicated by the data sets. Similarly, control unit 110 may correct fuel consumptions per hour of the ships based on overall lengths, molded breadths, etc. Namely, in the present invention, ship database 300 may store data sets indicating any type of information influencing fuel consumption required for movement of ships, and control unit 110 may specify fuel consumption required for movement of ships by use of the information indicated by the data sets.

In the above-explained exemplary embodiment, control unit 110 selects a ship whose fuel consumption is the least as a ship to be used for the routine transportation service. The present invention is not limited in this respect, and, for example, ship database 300 may store data sets indicating charter fees of the ships, and control unit 110 may calculate, in connection with each of the ships, a fuel fee corresponding to calculated fuel consumption and a charter fee, and select a ship to be used for the routine transportation service based on the results of the calculation.

In the above-explained exemplary embodiment, ship database 300 and meteorological and hydrographic phenomenon database 400 are configured as devices separate from ship allocating device 100 and connected with ship allocating device 100 via network 200. The present invention is not limited in this respect, and, for example, storage unit 120 of ship allocating device 100 may store ship database 300 and meteorological and hydrographic phenomenon database 400, and control unit 110 may obtain data sets from the database stored in storage unit 120.

In the present invention, data sets indicating information relating to the shipping route for the routine transportation service may be stored in storage unit 120 in advance. Ship allocating device 100 may display a list of candidate shipping routes indicated by the data sets stored in storage unit 120 to prompt the user to select a shipping route for the routine transportation service from the list.

In the above-explained exemplary embodiment, in response to an operation made by the user to ship allocating device 100, ship allocating device 100 indicates to the user information on the ships suitable for performing shipping assignments according to the routine transportation service designated by the user. The present invention is not limited in this respect, and, for example, ship allocating device 100 may be configured as a server device, and a terminal device functioning as a client device of the server device may transmit data sets indicating information on the routine transportation services input by the user to ship allocating device 100. Moreover, for example, data sets indicating results of calculations performed by ship allocating device 100 may be transmitted to the terminal device in which the data sets indicating information on the routine transportation service are stored, and the terminal device may display the results of calculations performed by ship allocating device 100.

In the present invention, in connection with each of marine areas that the ships pass through on the shipping route for the routine transportation service, data sets indicating vessel speeds of the ships may be input to ship allocating device 100. In this case, the process to calculate vessel speeds in SA5 is not required, and ship allocating device can calculate fuel consumption of the ships by use of the input vessel speeds.

In the above-explained exemplary embodiment, fuel consumption of the ships is calculated by use of information on meteorological and hydrographic phenomena. The present invention is not limited in this respect, and, for example, fuel consumption of the ships may be calculated without using information on meteorological and hydrographic phenomena. In this case, control unit 110 calculates fuel consumption of the ships based on a relation between vessel speed and fuel consumption per hour in normal weather without using a relation between vessel speed and fuel consumption per hour in heavy weather.

In the above-explained exemplary embodiment, ship allocating device 100 displays the ships suitable for performing a shipping assignment in accordance with a routine transportation service in connection with one schedule designated by the user. The present invention is not limited in this respect, and ship allocating device 100 may obtain plural schedules of the routine transportation service designated by the user, and display ships suitable for performing a shipping assignment in accordance with the routine transportation service in connection with each of the plural schedules.

For example, in the above-explained exemplary embodiment, ship allocating device 100 displays ships suitable for performing a shipping assignment in accordance with the routine transportation service in connection with a schedule in which a ship takes two weeks to move from port D to port E. Ship allocating device 100 may display ships suitable for performing the assignment in connection with a schedule in which a ship takes three weeks to move from port D to port E, in addition to the ships suitable for performing the assignment in connection with the schedule in which a ship takes two weeks to move from port D to port E, on the screen.

In the above-explained exemplary embodiment, the user inputs to ship allocating device 100 numbers of days required for moving between ports, a sailing date, etc. as information relating to the routine transportation service. The user may input to ship allocating device 100 numbers of hours required for moving between ports, sailing date, etc. as information relating to the routine transportation service. Namely, information on the schedule of assignments of ships for routine transportation service used by ship allocating device 100 should not be limited to indicating the schedule in units of days.

In the above-explained exemplary embodiment, ship allocating device 100 selects a designated number of ships used for the routine transportation service, and displays names of the selected ships. The present invention is not limited in this respect, and ship allocating device 100 may select a number of ships higher than the number of ships used for the routine transportation service in an increasing order of total fuel consumption, and display names of the selected ships. In this case, the user may designate the number of ships displayed by ship allocating device 100.

The program for realizing the functions of a device according to the present invention may be provided in a form of a computer readable recording medium storing the program such as a magnetic recording medium (for example, magnetic recording tape, magnetic disk such as Hard Disk Drive (HDD) and Flexible Disk (FD)), an optical recording medium (for example, optical disk), a magnet-optical recording medium, semiconductor memory, etc., and installed to ship allocating device 100. Alternatively, the program for realizing the functions of a device according to the present invention may be distributed from a server to ship allocating device 100 via network 200, and installed to ship allocating device 100.

### DESCRIPTION OF REFERENCE NUMERALS

1 . . . ship allocating system, 100 . . . ship allocating device, 110 . . . control unit, 111 . . . first data obtaining unit, 112 . . . second data obtaining unit, 113 . . . third data obtaining unit, 114 . . . calculating unit, 115 . . . selecting unit, 116 . . . outputting unit, 120 . . . storing unit, 130 . . . communication unit, 140 . . . operation unit, 150 . . . display unit, 200 . . . network, 300 . . . ship database (first database), 400 . . . meteorological and hydrographic phenomenon database (second database).

1-6. (canceled)

7. A device for allocating ships comprising:
a first data obtaining unit that obtains a shipping route data set indicating a shipping route of a routine transportation service, ship identification data sets that indicate candidate ships available for the routine transportation service, a ship number data set that indicates a number of ships used for the routine transportation service, and a schedule data set that indicates a schedule of assignments of ships for the routine transportation service;
a second data obtaining unit that obtains, from a first database that stores fuel consumption fluctuation data sets each of which indicates a fluctuation of fuel consumption of a ship in association with ship identification, data sets each of which in turn indicates a corresponding ship, fuel consumption fluctuation data sets stored in association with the ship identification data sets obtained by the first data obtaining unit;
a calculating unit that calculates, in connection with each of the candidate ships, fuel consumption required for the ship to traverse the shipping route indicated by the shipping route data set in accordance with a schedule indicated by the schedule data set based on the fuel consumption fluctuation data set of the ship;
a selecting unit that selects, from among the candidate ships, a number of ships equal to or greater than the number indicated by the ship number data set based on the fuel consumptions calculated by the calculating unit; and
an outputting unit that outputs the ship identification data sets of the ships selected by the selecting unit.

8. The device for allocating ships according to claim 7 further comprising:
a third data obtaining unit that obtains, from a second database, a meteorological and hydrographic phenomenon data set indicating meteorological and hydrographic phenomena in relation to the schedule indicated by the schedule data set and in relation to the shipping route indicated by the shipping route data set, wherein:
the first database stores meteorological and hydrographic phenomenon data sets in association with the fuel consumption fluctuation data sets; and
the calculating unit calculates the fuel consumption based on the meteorological and hydrographic phenomenon data sets.

9. The device for allocating ships according to claim 7, wherein:
the first data obtaining unit obtains a plurality of the schedule data sets,
the calculating unit calculates a fuel consumption of each of the candidate ships in connection with each of plural schedules indicated by the plurality of schedule data sets,
the selecting unit selects, in connection with each of the plural schedules, a number of ships equal to or greater than the number indicated by the ship number data set based on the fuel consumptions calculated by the calculating unit, and
the outputting unit outputs, in connection with each of the plural schedules, the ship identification data sets of the ships selected by the selecting unit, and
further comprising:
a display unit that displays, in connection with each of the plural schedules, the ship identification data sets output by the outputting unit.

10. A method for allocating ships, the method comprising:
obtaining a shipping route data set indicating a shipping route of a routine transportation service, ship identification data sets that indicate candidate ships available for the routine transportation service, a ship number data set that indicates a number of ships used for the routine transportation service, and a schedule data set that indicates a schedule of assignments of ships for the routine transportation service;
obtaining, from a first database that stores fuel consumption fluctuation data sets each of which indicates a fluctuation of fuel consumption of a ship in association with ship identification data sets, each of which in turn indicates a corresponding ship, fuel consumption fluctuation data sets stored in association with the obtained ship identification data sets;
calculating, in connection with each of the candidate ships, fuel consumption required for the ship to traverse the shipping route indicated by the shipping route data set in accordance with a schedule indicated by the schedule data set based on the fuel consumption fluctuation data set of the ship;
selecting, from among the candidate ships, a number of ships equal to or greater than the number indicated by the ship number data set based on the calculated fuel consumptions, and
outputting the ship identification data sets of the selected ships.

11. A program stored on a non-transitory computer readable medium that causes a computer to execute:
obtaining a shipping route data set indicating a shipping route of a routine transportation service, ship identification data sets that indicate candidate ships available for the routine transportation service, a ship number data set that indicates a number of ships used for the routine transportation service, and a schedule data set that indicates a schedule of assignments of ships for the routine transportation service;
obtaining, from a first database that stores fuel consumption fluctuation data sets each of which indicates a fluctuation of fuel consumption of a ship in association with ship identification data sets, each of which in turn indicates a corresponding ship, fuel consumption fluctuation data sets stored in association with the obtained ship identification data sets;
calculating, in connection with each of the candidate ships, fuel consumption required for the ship to traverse the shipping route indicated by the shipping route data set in accordance with a schedule indicated by the schedule data set based on the fuel consumption fluctuation data set of the ship;
selecting, from among the candidate ships, a number of ships equal to or greater than the number indicated by the ship number data set based on the calculated fuel consumptions, and
outputting the ship identification data sets of the selected ships.

12. A computer readable recording medium storing the program according to claim 11.
